(19) United States
(12) Patent Application Publication
(10) Pub. No.: US 2012/0117837 A1
(43) Pub. Date: May 17, 2012

(54) DEVICE HAVING A BAND-SHAPED INFORMATION CARRIER

(75) Inventor: Thomas Renner, Ulm (DE)

(73) Assignee: GARDENA MANUFACTURING GMBH, Ulm (DE)

(21) Appl. No.: 13/381,692

(22) PCT Filed: Jun. 28, 2010
(86) PCT No.: PCT/EP10/59130

§ 371 Date: Feb. 3, 2012

(30) Foreign Application Priority Data
Jul. 1, 2009 (DE) 102009031225.0

(51) Int. Cl. G09F 11/18; G09F 11/21

(52) U.S. Cl. 40/514

(57) ABSTRACT

The invention relates to a device, in particular a garden device, having a band-shaped carrier that comprises an operating manual or other information that is provided as a multi-layer roll in the resting position. According to the invention, a hollow chamber is integrated in the device housing as a carrier support for the wound carrier and/or a self-winding film is used as a carrier.

The invention relates to a device, especially a garden device, with an information carrier that can be read by a user.

DE 1912819 U1 describes a container for operating instructions, instructions for use and the like which is intended in particular for use in conjunction with a garden device. The container is designed to be tubular and contains a printed strip wound on a roller shaft in a position of rest. The strip is fastened by an inner end on the roller shaft and can be pulled outward by pulling on its end extending out through a slotted opening of the tube body into a position of use and be wound off from the roller shaft counter to a return force of a winding spring. In a manner similar to that in spring blinds, a stop in the position of use can be provided, after the loosening of which the strip is wound up again from the position of use under the action of the winding spring into the position of rest on the roller shaft. The tubular container can be fastened by a clamp on a device, in particular on a device handle.

The present invention has the basic task of further improving a combination of a device with operating instructions or the like.

The invention is described in the independent claim. The dependent claims contain advantageous embodiments and further developments of the invention.

A better protection of the carrier against damage or loss is given by the integration of the carrier receptacle into the device housing as a hollow chamber designed for the carrier and at the same time the necessity for a separate structural part is eliminated, which is especially advantageous in the case of a device housing formed by one or several plastic injection moulding parts.

In a first advantageous embodiment the hollow chamber comprises a slot-. shaped opening through which the band-shaped carrier is passed. A second end of the carrier that is held in the hollow chamber can advantageously have a widened-out part in the surface of the carrier and/or in the direction of the normal of the surface of the carrier that is greater than the dimension of the slot-shaped opening and secures the second end of the carrier against being completely pulled out of the hollow chamber without the second end being fastened in the hollow chamber to the housing of the device. The second end of the carrier forms in the rest position of the carrier the inner end of the multi-layer winding.

In another embodiment the opening of the hollow chamber can be so large that the winding of the band-shaped carrier can be moved outward out of its position of rest by the handle element through the opening and away from the hollow chamber during the winding off of the carrier. The second end, held in the hollow chamber, forms the outer end of the winding here in the position of rest of the carrier and the first end of the carrier forms the inner end of the winding, that is rotatably supported about the winding shaft relative to the handle element. Such an embodiment is particularly advantageous when using a carrier film that automatically rolls up.

The limitation of the hollow chamber surrounds the winding formed by the carrier in the position of rest over at least 180°, especially at least 240°, relative to the winding shaft. In the case of a slotted opening the winding is advantageously almost completely surrounded by the limitation of the hollow chamber.

The use of a self-winding film as carrier of visually readable information considerably simplifies the construction of the device regarding the carrier and the device components cooperating with the latter since in particular a separate winding mechanism with a winding spring is eliminated and the band-shaped carrier rolls up itself to a winding under the action of an inner tension produced during the manual pulling out of the carrier into the stretched position of use upon the release of the stretching force.

The self-winding film is advantageously connected by one of its two ends to a winding core. The winding core can be an inherently stable, in particular a tubular core body or be formed by several winding layers of the film itself that are connected to each other, e.g., adhered, and thus secured against winding off.

Such self-winding films, that are typically formed by several laminated layers, are known, e.g., from U.S. Pat. No. 5,176,774A, U.S. Pat. No. 6,1760,28B1, U.S. Pat. No. 5,966,854A, U.S. Pat. No. 4,848,437A or DE202007014034U1 in various applications, whereby typically a first end of a film band is constructed to be stationary and a film winding can be pulled away from the fixed end during unwinding. A handle is typically connected to the film winding and is rotatably placed at the side of the winding.

The integration of the carrier receptacle as a hollow chamber into the device housing on the one hand and a formation of the band-shaped carrier on the other hand can be advantageously realized individually as well as preferably in combination.

In particular in the preferred embodiment for the carrier consisting of a self-winding film in the hollow chamber of the device housing the carrier can be advantageously designed to be floating in the hollow chamber, i.e., without a roller shaft rotatably held on a support, which is advantageous as regards the simple construction of the carrier and the formation of the hollow chamber as well as during the assembly.

In a first advantageous embodiment the hollow chamber is formed by two partial shells of a device housing that each form a part of the limitation of the hollow chamber. The slot-shaped opening, through which the first free end of the carrier extends outward out of the hollow chamber with a gripping section and through which the carrier is moved during the unwinding into the stretched position of use and during the rewinding into the hollow chamber, is advantageously formed between facing edges of a first and of a second partial shell of the device housing that are distanced from one another at this location.

In another advantageous embodiment the hollow chamber can have an opening to an outer surface of the housing that is larger compared to the slot-shaped through opening and that can be closed by a detachable covering element. When the cover element is separated, this larger opening offers the advantageous possibility of inserting a wound-up carrier readily into the hollow chamber or remove it from the hollow chamber. The cover element in the closed state forms, with an element edge opposite a housing edge at a distance from the latter, the slot-shaped opening for passing the band-shaped carrier through it. The cover element can advantageously be removed as a cover or pivoted up as a flap.

Even in the embodiment with a larger opening of the hollow chamber and the moving of the winding out of the hollow chamber during the change from the position of rest into the position of use a cover element that can be moved with the handle and the winding can advantageously be provided that covers the opening in the rest position of the carrier.

The arrangement of the carrier receptacle as a hollow chamber integrated into the device housing in combination with at least one operating element that is arranged on the device, in particular on a housing surface of the device housing designated in the following as operating surface and that is for the adjusting of at least one changeable operating parameter of the device, preferably a changeable adjustment of an electronic control apparatus of the device or also of a mechanical adjusting element is especially advantageous. Simple turning on and/or off elements for the basic operation of the device are not understood as operating element in this sense. The operating element can preferably be actuated with one hand by a user. The information carrier is then advantageously arranged in such a manner in the device housing that in the position of use of the carrier extended in particular by a hand of the user a side of the carrier comprising visually readable information can be seen by a user simultaneously with the operating element and the operating element can be actuated by the user with the other hand. It is preferable if the operating surface is substantially level and the opening for passing the carrier through is arranged underneath the operating element and/or on a lateral surface transverse to the operating surface so that the side of the carrier carrying the information is located in its position of use laterally to and/or underneath the operating element in the field of view. The carrier can also be held by an additional holding element in the extended position which cooperates in the area of the handle with the latter or with an element associated with the latter. Also, a separate carrier housing can be fastened on the device housing in such a manner that the simultaneous visual detecting of the carrier information and of the at least one operating element is possible by the user.

The invention is illustrated in detail in the following using preferred exemplary embodiments with reference made to the drawings, in which

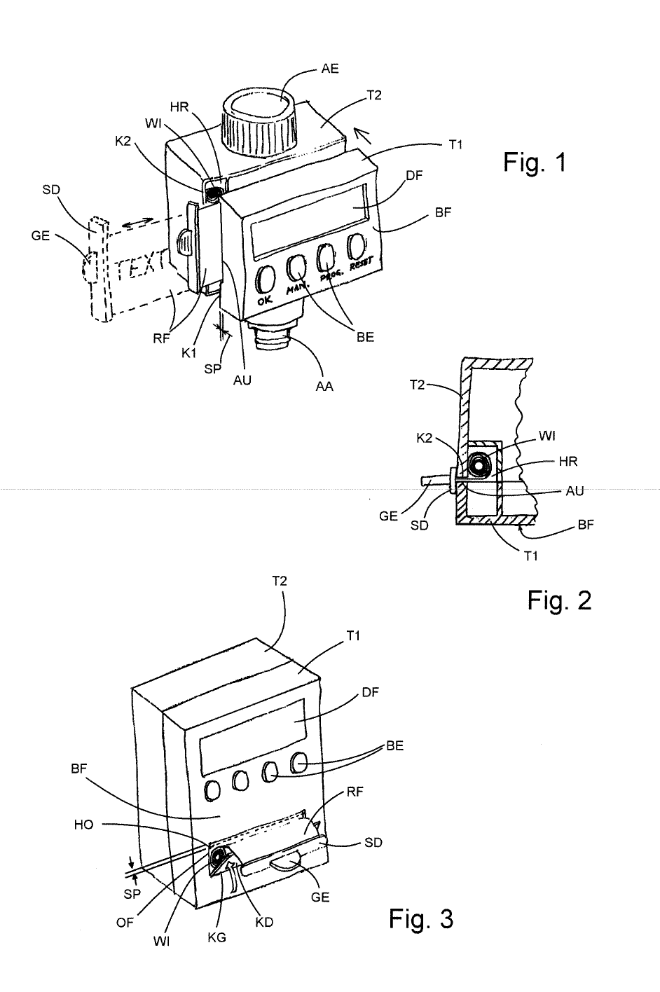

FIG. 1 shows an embodiment with a hollow chamber formed between two partial shells of the housing,

FIG. 2 shows a section through a part of the housing,

FIG. 3 shows an embodiment with a hollow chamber that can be closed by a cover element,

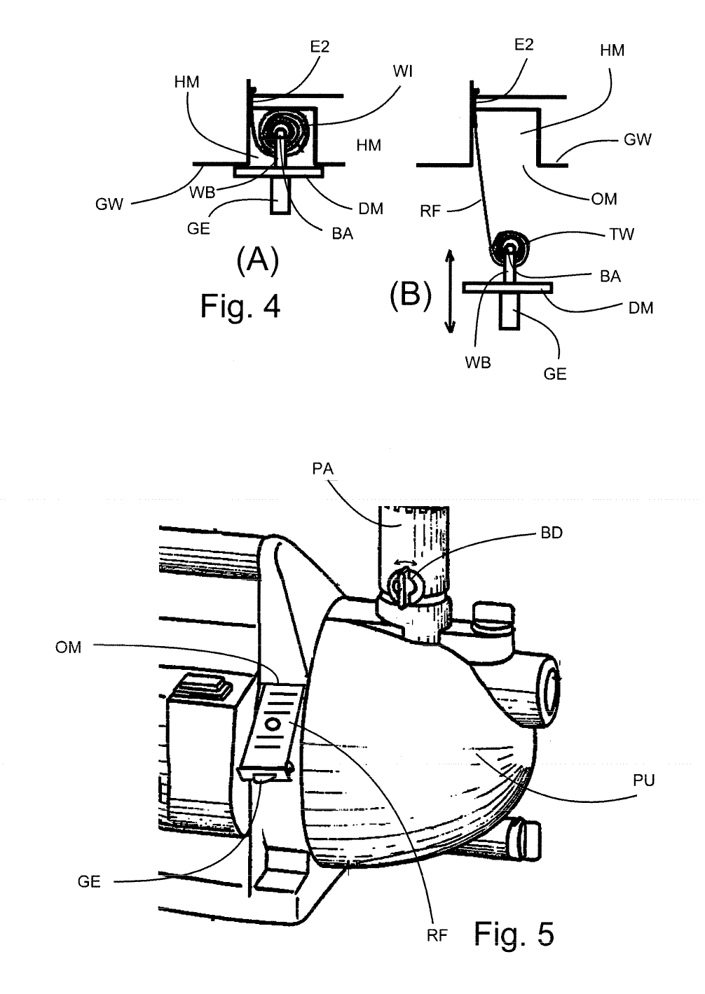

FIG. 4 shows an embodiment with a carrier winding rotatably supported on the handle element,

FIG. 5 shows a use on a pump.

FIG. 1 shows an electronic irrigation control apparatus in an oblique view as a preferred usage that can be connected by an input connection AE to a water cock, in particular by a threading. An output connection has a nipple for an plug coupling. An electromagnetically actuatable cut-off valve inside the housing that releases or blocks the flowthrough of water from the input connection AE to the output connection AA in accordance with criteria that can be inputted by a user is not shown. Such devices are also generally known under the designation of irrigation computers.

The device housing contains a first housing partial shell T1 and a second housing partial shell T2. The input connection AE and the output connection AA are arranged on the second housing shell T2. In the sketched, advantageous example the first housing shell T1 contains electronic elements of a control apparatus connected via wiring or via plug contacts to the electromagnetic shutoff valve located in the second housing partial shell T2 at least in the assembled housing partial shells. The two partial shells T1 and T2 are shown in FIG. 1 in a position separated from one another in order to free a view into a hollow chamber HR in which a winding W1 of a band-shaped carrier is located. The two partial shells are joined together in the direction of the arrow in order to form the housing.

The partial shells T1, T2 face one another with housing edges K1 and K2 and a recess AU is provided in at least one of the two edges K1 or K2. During the joining together of the two partial shells to the device housing, the edges K1 and K2 are joined together outside of the area of the recess AU to a tight housing joint. In the area of the recess AU a slot-shaped recess remains whose width is substantially the width of the band-shaped carrier RF and whose depth in the direction of the normal of the surface of the band-shaped carrier RF is designated with SB. The depth SP of the recess is greater than the thickness of the band-shaped carrier and forms a slot-shaped opening when the housings are joined together through which the band-shaped carrier RF can be moved through in a substantially free manner.

The housing comprises several operating elements BE on an operating surface BF of the partial shell T1 by means of which the user can adjust and change control parameters of the control apparatus. The operating elements BE are designed as keys in the sketched exemplary case. However, slides, rotary switches or other operating elements can also be provided. A display surface DF can additionally be provided for interactive input. The operating surface is preferably substantially level.

The slot-shaped opening formed by the recess AU for passing the band-shaped carrier RF through is arranged in a side surface SF of the housing running transversely to the operating surface.

A band-shaped carrier RF that is preferably constructed as a self-winding film lies in a rest state with a multi-layer winding part WI in a hollow chamber HR of the housing. The hollow chamber HR is freely accessible when partial shells T1, T2 are separated, as shown in FIG. 1, in order to insert the winding WI of the carrier RF into the hollow chamber. After joining the partial shells T1, T2 to the housing, the hollow chamber is substantially closed on all sides and the first partial shell T1 as well as the second partial shell T2 form limiting surfaces of the hollow chamber. The limitation of the hollow chamber can be designed to be watertight against an inner chamber of the device. The slot-shaped opening formed by the recess AU forms a through passage opening between the hollow chamber HR and the outside space. A first outer end of the band-shaped carrier is connected to a handle element GE and advantageously rendered inherently stabilized over the entire width of the band-shaped carrier by a closing element with a stiff form. In the state of rest, that is represented in the sectional view of a section through the housing, the closing element forms the covering element for covering the slot-shaped opening in the device housing. In this state of rest the covering element SD rests on the side surface SF of the device housing due to a slight residual tension of the force bringing about the winding up of the band-shaped carrier, which residual tension also advantageously remains in the state of rest.

The carrier can be wound off from the winding W I by pulling on the handle element

GE counter to a return force acting in the direction of a winding up of the carrier. FIG. 1 shows an initial partial pulled-out position with a solid line and a larger or also completely pulled-out position as position of use with a interrupted line. In the position of use information applied on the band-shaped carrier can be visually read. In the extended position of use of the band-shaped carrier present in extended form the information that can be visually read off it can advantageously be visually detected by a user simultaneously with the operating surface BF. It should be understood that the term simultaneously denotes that the user does not have to make any change in the position of his body in order to observe the operating surface BF and read off the information from the carrier RF. It is especially advantageous if the operating elements can be operated with one hand so that the user can hold the tensioned carrier in the extended form in the pulled-out position of use with one hand and can actuate the operating elements with the other hand, during which information given on the carrier for actuating the operating elements can be converted in an especially advantageous manner into an actuation of the operating elements by the simultaneous visual detection.

The embodiment of operating elements as pressure keys is only to be understood as an example. In particular, even in the case of irrigation computers embodiments with a rotary knob for selecting one of several stored irrigation programs are known, in which case the pulled-out carrier can then give the user a detailed description of the individual programs.

In order to put the band-shaped carrier back into the rest state with a band-shaped carrier forming a winding WI in the hollow chamber HR, the user only has to reduce the pulling-out force to the extent that the band-shaped carrier is wound up again under the return force built up during the pulling out of the carrier, in particular in the preferred usage of a self-winding film as carrier that winds itself up to a winding WI in the hollow chamber FIR.

FIG. 3 shows a variant of the structural form of FIG. 1 in which a hollow space HO that receives the wound-up carrier is not closed on all sides by the housing but rather is open to the outside via a large opening OF through an outer surface of the housing, in the sketched instance the widened operating surface BF, and is accessible for removing or inserting a carrier winding. The large opening OF in the outer surface of the housing can be largely closed by a covering element KD, in which case a through opening for the band-shaped carrier from the hollow chamber HO to the outside is advantageously formed in that in a closed state of the covering element an edge of the covering element is distanced from the housing by a slot width SB and allows the movement of the band-shaped carrier during winding up or winding off between the hollow space HO and the outside space. In particular, the covering element KD can be constructed as a completely removable cover or as a flap that can pivot along a hinge, for example, a plastic film hinge. The covering element can advantageously be stopped, in particular locked, in the closed position. The covering element can be detached from the closed position without being destroyed and pivoted into the open position or removed from the housing opening OF. FIG. 3 shows an open or partially closed position of a pivotable covering element.

FIG. 4 shows an embodiment in analogy with FIG. 2 as a sectional view through the hollow chamber viewed in the direction of the winding shaft of a winding of a band-shaped carrier in which a second end E2 of the band-shape information carrier is permanently connected to the housing GW of a device. In the position of rest of the carrier shown in FIG. 4 (A) the carrier is wound to a winding WI in a hollow chamber HM and the hollow chamber HM is constructed as a recess against an outer surface of the housing GW. The winding WI is preferably wound onto a winding core to which the first end of the stretchable, band-shaped carrier is fastened. The winding core can also be formed by several layers of the band-shaped carrier itself that are connected, in particular adhered, to each other in such a manner that they can not be wound off. The transition from the stretchable part of the band-shaped carrier onto the winding core is considered as the first end of the band-shaped carrier.

The handle element GE is connected to a bracket WB that engages with a bracket shaft BA into the winding core or grasps it somewhere else in a rotatable manner, for example, grasps a winding core projecting over the width of the band-shaped carrier. The handle element GE with the bracket WB is connected relative to the winding core or to the winding WI in such a manner that it can rotate about the bracket shaft BA or the winding shaft of the winding parallel to the latter. The bracket SB is drawn into the hollow chamber HM by the tension of the band-shaped carrier, that has a winding-up action. Furthermore, a plate-shaped covering element DB is connected to the handle element GB and to the bracket WB that covers the opening of the hollow chamber designated in FIG. 4 (B) with OM in the position of rest of the carrier shown in FIG. 4 (A) and thus protects the carrier in its position of rest against contamination.

The covering element, the handle element or the bracket can also be held in the rest position by an additional holding force that can be given, for example by a mechanical structure or by a magnetic arrangement.

The handle element GE and covering element DM and bracket WB can be drawn away from the hollow chamber by the action of a pulling force by the user on the handle element GE, during which the band-shaped carrier is wound off from the winding WI and the residual winding designated in FIG. 4 (B) with TM is drawn out of the hollow chamber and moved away from it. FIG. 4 (B) shows an intermediate position with partial unwinding of the band-shaped carrier RF from the winding. During a complete unwinding the band-shaped carrier is stretched between the second end E2 held fast in the device housing and between the first end fastened to the winding core under elastic tensioning and information printed at least one side of the band-shaped carrier is visually readable for a user. Upon reduction of the tractive force by the user and movement of the handle element in the direction of the device housing the band-shaped carrier is again wound onto the winding core that can rotate about the winding shaft WA and/or the bracket shaft BA until the rest position of the carrier shown in FIG. 4 (A) is reached. The band-shaped carrier advantageously consists here of a self-winding film so that an especially simple arrangement is produced. Handle elements with brackets that are rotatably connected to a winding core of a self-winding film are basically known from the prior art in various ways when using self-winding films.

FIG. 5 shows a pump PU as a device that has on the pump output PA an operating element BD in the form of a rotary knob that can rotate manually into various operating positions. A spring-loaded non-return valve at the pump output can be obligatorily opened with such a rotary knob in a pump in a customary manner during an intake phase so that air present in the pump can more readily escape and as a result the intake procedure is facilitated when drawing in from a pressureless container. During the operation of the pump the non-return valve should remain closed in order to prevent a backflow of water through the pump. Furthermore, it can be provided that the non-return valve is obligatorily opened for the purposeful emptying of the pump. The rotary knob BD can thus be moved in various operating modes, in particular intake, regular operation and emptying, into various positions.

A band-shaped information carrier RF is shown in a partially or completely pulled-out state in which information present on the carrier RF can be visually read by the user. For the sake of clarity a hand of the user gripping the handle element GE is not sketched in. When the information carrier is pulled out, the user can gather from the instructions present on the carrier into which position the operating element BD is to be set for which operating mode, i.e., in particular intake, regular operation or emptying. If the user no longer requires help for the operation from the carrier RF, the band-shaped carrier can be wound up on the winding core under its intrinsic tension and be stored as a winding behind opening OM in a hollow chamber in the outer surface of the housing.

The invention is not limited to the described exemplary embodiments but rather can be modified in many ways within the framework of professional ability.

1. A device, in particular a garden device, with a band-shaped carrier (RF) with visually readable information that lies rolled up in a carrier receptacle in a rest position as winding (WI) and can be pulled out of this receptacle by a handle element (GE) arranged on a first free end of the carrier manually through an opening against a return force in the carrier receptacle, rolling off in the form of a position of use extended outside of the carrier receptacle, and can be moved back under the action of the return force, winding up into the position of rest, characterized in that the carrier receptacle is formed by a hollow chamber (HR, HO) integrated into the device housing of the device and/or that the carrier (RF) is formed by a self-winding film.

2. The device according to claim 1, characterized in that the opening is slot-shaped.

3. The device according to claim 1 or 2, characterized in that the hollow chamber (HO) can be closed by a detachable covering element (KD).

4. The device according to claims 2 and 3, characterized in that when the hollow chamber (HO) is closed, the slot-shaped opening is present between a movable edge of the covering element (KD) and the device housing for passing the band-shaped carrier through it.

5. The device according to claim 1, characterized in that the device housing comprises at least two partial shells (T1, T2) that each form a part of the limitation of the hollow chamber (HR).

6. The device according to claims 2 and 5, characterized in that the slot-shaped opening for passing the carrier through it is present between the facing edges (K1, K2) of the two partial shells (T1, T2).

7. The device according to one of claims 2 to 6, characterized in that a second end of the carrier that is located in the hollow chamber even in the pulled-out position of use has a widened-out part that is larger than the dimension of the slot-shaped opening.

8. The device according to one of claims 2 to 7, characterized in that one end of the carrier is fastened to a winding core.

9. The device according to one of claims 2 to 8, characterized in that the carrier lies in the hollow chamber in a floating manner.

10. The device according to claim 1, characterized in that a second end of the carrier is fastened as the outer end of the winding to the device and that the winding about the winding shaft is rotatably connected to the handle element.

11. The device according to one of claims 1 to 10, characterized in that at least one manually operated operating element (BE) for adjusting changeable operating parameters of the device is arranged on the device housing.

12. The device according to claim 11, characterized in that a side of the carrier (RF) pulled-out into the position of use and the operating element (BE) can be simultaneously viewed by the user.

13. The device according to one of claims 1 to 12, characterized in that the first free end of the carrier is connected to an inherently stable covering (SD) for the opening.
